(19) United States
(12) Patent Application Publication
(10) Pub. No.: US 2025/0051225 A1
(43) Pub. Date: Feb. 13, 2025

(54) OPTICAL FIBER MARKING ON THE DRAW

(71) Applicant: CORNING INCORPORATED, CORNING, NY (US)

(72) Inventors: Andres Covarrubias Jaramillo, Hampstead, NC (US); John Randolph Phillips, Wilmington, NC (US)

(21) Appl. No.: 18/779,667

(22) Filed: Jul. 22, 2024

Related U.S. Application Data
(60) Provisional application No. 63/532,106, filed on Aug. 11, 2023.

(51) Int. Cl. C03C 25/1065; B41J 3/407; B41M 3/00; B41M 5/00; B41M 7/00; C03B 37/029; C03C 25/143

(52) U.S. Cl. CPC C03C 25/1065; B41J 3/40733; B41M 3/003; B41M 5/007; B41M 5/0088; B41M 7/0081; C03B 37/029; C03C 25/143; C03B 2205/60

(57) ABSTRACT

An optical fiber draw system that prints one or more fiber identifiers on optical fibers is described. In one example, the optical fiber draw system includes a draw furnace, a coating device, a marking device, and a lighting device. The draw furnace generates a glass fiber from a glass preform and the coating device is configured to apply a curable coating composition to the glass fiber. The lighting device applies an ultraviolet or other curing light to form a coating from the curable coating composition. The application and curing of a curable coating composition can be completed one or more times to form one or more coatings on the glass fiber. The marking device applies a tracer marking fluid to a curable coating composition or coating and can be placed at one or more positions along the process pathway.

This application claims the benefit of priority under 35 U.S.C § 120 of U.S. Provisional Application Ser. No. 63/532,106 filed on Aug. 11, 2023, the content of which is relied upon and incorporated herein by reference in its entirety.

### BACKGROUND

Optical fibers are coated strands of glass fiber that can be used to transmit high bandwidth information over long distances. Multiple optical fibers can be packaged in a cable line. One or more of the optical fibers can have a unique marker to enable identification of the individual optical fibers in the cable. The unique markers can be useful for tracing individual optical fibers during splicing, connecting, installation, and maintenance of cables in fiber optics networks.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an optical fiber draw system, according to one embodiment described herein.

FIGS. 2A-2C are drawings of a drop on demand printer and an optical fiber line, according to one embodiment described herein.

FIG. 3A is a drawing of an optical fiber process, according to one embodiment described herein.

FIGS. 3B and 3C are drawings of a fiber substrate, according to one embodiment described herein.

FIGS. 3D-3E are alternative views of the optical fiber process, according to one embodiment described herein.

FIG. 4. is a flowchart illustrating a first example of a process for tracer marking using a drop on demand printer according to various embodiments of the present disclosure.

FIG. 5 is a flowchart illustrating a second example of a process for tracer marking using a drop on demand printer according to various embodiments of the present disclosure.

### SUMMARY

The present disclosure extends to:

A system for forming an optical fiber, comprising:
a draw furnace configured to produce a glass fiber from a glass preform;
a first coating system configured to receive the glass fiber and to deliver a first curable coating composition to the glass fiber, the first curable coating composition surrounding the glass fiber;
a first lighting device configured to receive the glass fiber from the first coating system and to apply first light to the first curable coating composition, the first light curing the first curable coating composition to form a first coating on the glass fiber; and
a marking device operably coupled to the first coating system of the first lighting device, the marking device configured to apply a tracer marking fluid to the first curable coating composition or the first cured coating layer, the tracer marking fluid comprising a coloring agent and a carrier liquid.

The present disclosure extends to:

A method of making an optical fiber comprising:
drawing a glass fiber from a heated glass preform;
directing the glass fiber to a first coating system, the first coating system applying a first curable coating composition to the glass fiber, the first curable coating composition surrounding the glass fiber; and
directing the glass fiber with first curable coating composition to a first lighting device, the first lighting device providing first light to cure the first curable coating composition to form a first coating, the directing including applying a tracer marking fluid to the first curable coating composition or the first coating.

The present disclosure extends to:

A method for marking an optical fiber comprising:
conveying a fiber substrate at a line speed greater than 40 m/s, the fiber substrate comprising a curable coating composition or a coating disposed on a glass fiber; and
while conveying the fiber substrate, applying a tracer marking fluid to the curable coating composition or coating.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims that follow, reference will be made to a number of terms which shall be defined to have the following meanings:

“Include,” “includes,” “including”, or like terms means encompassing but not limited to, that is, inclusive and not exclusive.

The indefinite article “a” or “an” and its corresponding definite article “the” as used herein means at least one, or one or more, unless specified otherwise. The term “plurality” means two or more.

Directional terms as used herein—for example up, down, right, left, front, back, top, bottom—are made only with reference to the figures as drawn and the coordinate axis provided therewith and are not intended to imply absolute orientation.

Where a range of numerical values is recited herein, comprising upper and lower values, unless otherwise stated in specific circumstances, the range is intended to include the endpoints thereof, and all integers and fractions within the range.

As used herein, “comprising” is an open-ended transitional phrase. A list of elements following the transitional phrase “comprising” is a non-exclusive list, such that elements in addition to those specifically recited in the list may also be present.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are rigidly or flexibly joined through one or more intervening materials.

“Optical fiber” refers to a waveguide having a glass portion surrounded and contacted by one or more coatings or coating compositions. The glass portion includes a core and a cladding. The cladding surrounds and is directly adjacent to the core and includes two or more concentric regions that differ in refractive index. The refractive index of the core is greater than the refractive index of the cladding. The glass portion of the optical fiber is referred to herein as a “glass fiber”.

The coatings described herein are formed from curable coating compositions. Curable coating compositions include one or more curable components. As used herein, the term “curable” is intended to mean that the component, when exposed to a suitable source of curing energy, includes one or more curable functional groups capable of reacting to form covalent bonds that participate in linking the component to itself or to other components of the coating composition. Curable functional groups include acrylate groups and methacrylate groups. The product obtained by curing a curable coating composition is referred to herein as the cured product of the curable coating composition or as a coating. The cured product is preferably a polymer. The curing process is induced by energy. Forms of energy include radiation or thermal energy. In a preferred embodiment, curing occurs with radiation, where radiation refers to electromagnetic radiation. A radiation-curable component is a component that can be induced to undergo a photochemical curing reaction when exposed to radiation of a suitable wavelength at a suitable intensity for a sufficient period of time. Suitable wavelengths depend on the curable component and typically include wavelengths in the infrared (750 nm-2000 nm), visible (400 nm-750 nm), or ultraviolet (200 nm-400 nm) portion of the electromagnetic spectrum. The radiation curing reaction may occur in the presence of a photoinitiator. A radiation-curable component may also be thermally curable. Similarly, a thermally curable component is a component that can be induced to undergo a curing reaction when exposed to thermal energy of sufficient intensity for a sufficient period of time. A thermally curable component may also be radiation curable. In some embodiments, the tracer marking fluid comprises a curable composition; preferably a radiation-curable composition.

A coating composition applied to a glass fiber is said herein to be disposed on the glass fiber. As used herein, “disposed on” means in contact with, where contact refers to direct contact or indirect contact. Reference is made herein to primary, secondary, and tertiary coatings based on proximity of the coating to the glass fiber. A primary coating is disposed on a glass fiber and is in direct contact with the glass fiber. A secondary coating is disposed on a glass fiber, disposed on a primary coating, in indirect contact with a glass fiber, and in direct contact with a primary coating. A tertiary coating is disposed on a glass fiber, disposed on a primary coating, disposed on a secondary coating, in indirect contact with a glass fiber, in indirect contact with a primary coating, and in direct contact with a secondary coating. Most commonly, a primary coating surrounds and directly contacts the glass fiber, a secondary coating surrounds and directly contacts the primary coating, and a tertiary coating surrounds and directly contacts the secondary coating. In some embodiments, a tertiary coating is absent or optional. In other embodiments a tertiary coating is present and is colored.

The term “contiguous”, when used in reference to a plurality of elements, means that the elements are in direct contact with each other with no intervening gaps.

The embodiments of the present disclosure relate to using a marking device for producing tracer markings on a coating composition or coating of an optical fiber during a manufacturing process that includes drawing a glass fiber from a preform, applying a coating composition to the glass fiber and forming a coating from the coating composition. Typically, a tracer or ring marking process for unique fiber identification uses a continuous inkjet printing system to print black tracer marks on optical fibers. In continuous inkjet printing, an optical fiber is conveyed at a line speed past an inkjet printhead. The inkjet printhead applies a tracer marking fluid consisting of a continuous stream of ink droplets at selected locations on the coating of an optical fiber. The ink droplets form a tracer marking that is used to label the optical fiber. The tracer marking consists of a series of ink droplets aligned along the length of the optical fiber. The size of the tracer marking can be varied by switching the inkjet printhead on and off to control the time of exposure of the optical fiber to the continuous stream of ink droplets. Unique tracer markings are applied to individual optical fibers in order to enable identification of the individual optical fibers when they are bundled in a cable. Continuous inkjet printing methods have been demonstrated to work for line speeds up to 19 meters/second (m/s). Detrimental effects on the quality of tracer markings and the performance of marked optical fibers have been observed when the line speed is increased further. In particular, as line speed increases, it becomes difficult to maintain the positioning or spacing of the tracer markings or the ink droplets within a tracer marking due to limitations in the rate of delivery of ink from continuous inkjet printheads. Improper placement of tracer markings or ink droplets can cause increased signal loss in the optical fiber due to micro-bending effects. Draw processes used to manufacture optical fibers from glass preforms, in contrast, are typically run at line speeds well above 19 m/s (e.g., 50 m/s) to optimize process efficiency. There is therefore a need for processes capable of applying tracer marking fluids to optical fibers to form tracer markings at higher line speeds. In particular, there is a need for a process that enables application of tracer marking fluids to a curable coating composition or coating of an optical fiber at line speeds commensurate with the line speed at which glass fiber is drawn from a glass preform in a draw process used to manufacture optical fibers.

To address this need, the embodiments of the present disclosure introduce systems and methods that include a marking device used on an optical fiber draw apparatus for producing applying a tracer marking fluid to a curable coating composition or coating of an optical fiber. In some examples, the present disclosure of embodiments describes various configurations for incorporating drop on demand technology and various techniques as the marking device for applying a tracer marking fluid on an optical fiber coating online during a draw process in which glass fiber is drawn from a glass preform and coated with one or more coatings. In the context of the present disclosure, drop on demand represents droplet generation technology from a marking device that generates one or multiple droplets on command (e.g., upon receipt of an electrical signal or actuator control). If multiple droplets are requested, the multiple droplets are generated simultaneously (e.g., multiple nozzles of a marking device firing simultaneously or nearly simultaneously), or alternatively with set time delays relative to each nozzle. Marking devices that implement drop on demand printing technology include, but are not limited to, industrial inkjet printers, piezo-actuated printheads, thermal inkjet (TIJ), micro dispensing valves, and large character printers.

The marking device can be located at one or more positions along the draw path of an optical fiber draw apparatus. In embodiments, the marking device is positioned to enable application of a tracer marking fluid on (1) an uncured primary coating composition, (2) a primary coating (cured product of the primary coating composition), (3) an uncured secondary coating composition, (4) a secondary coating (cured product of the secondary coating composition), (5) an uncured tertiary coating composition, and/or (6) a tertiary coating (cured product of the tertiary coating composition).

The embodiments of the present disclosure provide one or more improvements from prior approaches. For example, the embodiments of the present disclosure enable faster line speeds for application of a tracer marking fluid to a curable coating composition or coating of an optical fiber and in particular, enable application of a tracer marking fluid at line speeds compatible with the draw speed of glass fiber in an optical fiber draw apparatus and process without compromising the quality or integrity of tracer marks formed from the tracer marking fluid. As a result, it becomes possible to integrate the marking device with the draw apparatus and form tracer marks online in the fiber draw process. The need for applying the tracer marking fluid and forming tracer marks therefrom in an offline process after production of the optical fiber is obviated and overall process efficiency is improved. In some instances, the embodiments can operate at higher line speeds while maintaining conformity of tracer marks with the TIA-598D standard for tracer marks. In embodiments in which the tracer marking fluid is applied to an uncured coating composition and the tracer marking fluid is curable, the coating composition and tracer marking fluid can be cured simultaneously in a curing station of the optical fiber draw apparatus. These embodiments may create a monolithic layer in which tracer marks formed from the tracer marking fluid are integrated with the coating instead of being formed as distinct layer on the surface of the coating. In the following discussion, a general description of the optical fiber draw system and its components is provided, followed by a discussion of the operation of the same.

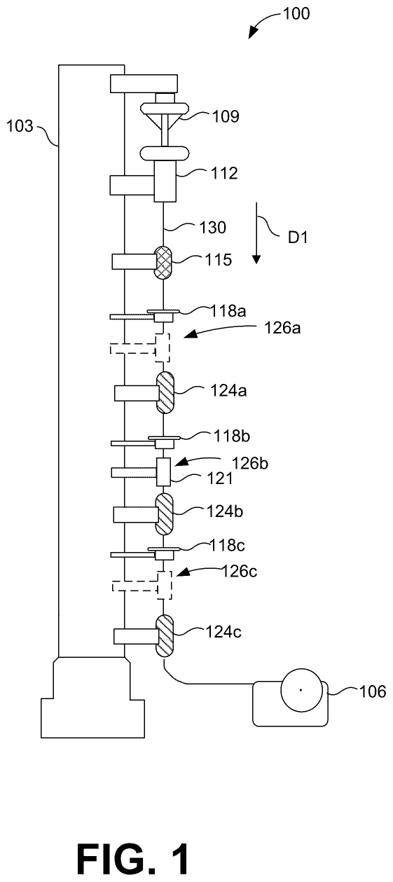

With reference to FIG. 1, shown is drawing of an optical fiber draw system 100 according to one embodiment. In one embodiment, the optical fiber draw system 100 includes a draw tower structure 103, an optical fiber spool 106, a preform feed 109, a draw furnace 112, a cooling chamber 115, a first coating system 118a, a marking device 121, a first lighting device 124a, a second coating system 118b, a second lighting device 124b, a third coating system 118c, a third lighting device 124c, and other suitable components operably coupled to each other along a process path extending from draw furnace 112 to optical fiber spool 106.

The draw tower structure 103 is a structure that has multiple attachment points for various components of the optical fiber draw system 100. The components are attached at different points to manufacture and control the drawing process for a glass fiber 130 that traverses a process path extending from draw furnace 112 to optical fiber spool 106. The height of the draw tower structure 103 can vary. Oftentimes, the height of the draw tower structure 103 can vary between five and forty-five meters. It should be noted that other structures may be used for the optical fiber draw system 100 instead of the draw tower structure 103.

The optical fiber spool 106 is a spool apparatus for collecting the optical fiber that has completed the optical fiber draw process. The optical fiber collected by the optical fiber spool 106 includes glass fiber 130, coatings formed thereon along the process pathway in optical fiber draw system 100, and tracer markings applied as described herein. The preform feed 109 holds and conveys a glass preform to and within draw furnace 112. The glass preform is the glass source material from which glass fiber 130 is drawn. The draw furnace 112 is an apparatus for heating the tip of the glass preform to a softening point to enable the drawing of a glass fiber therefrom. The glass fiber 130 travels from the draw furnace 112 through various components of the optical fiber draw system 100 and then continues to the optical fiber spool 106 along a process pathway in a draw direction, as indicated by arrow D1. The cooling chamber 115 is used to lower the temperature of the glass fiber to optimize the optical performance of the glass fiber 130 and to prepare the glass fiber 130 for application of a curable coating composition in the remaining coating and marking processes.

The first coating system 118a, a second coating system 118b, and a third coating system 118c (collectively “the coating systems 118”) are apparatuses that apply curable coating compositions to the glass fiber 130. The first coating system 118a applies a curable primary coating composition to glass fiber 130, the second coating system 118b applies a curable secondary coating composition to the primary coating, and the third coating system 118c applies a curable tertiary coating composition to the secondary coating. In some embodiments, each coating system 118 includes a coating die and each coating die may apply a different curable coating composition. For example, the primary coating formed from the curable primary coating composition is typically a low modulus coating (e.g., Young's modulus<1 MPa), while the secondary and tertiary coatings formed from the curable secondary and tertiary coating compositions are typically high modulus coatings (e.g., Young's modulus>1000 MPa). In one embodiment, the primary coating and secondary coating are colorless and the tertiary coating is colored, where the coloring is preferably uniform throughout and along the length of the tertiary coating.

In some embodiments, the marking device 121 is a parallel printer device in which an array or pattern of ink droplets are deposited or printed simultaneously at multiple positions along a curable coating composition or coating disposed on glass fiber 130. In some examples, the marking device 121 includes multiple nozzles in a parallel configuration, in which each nozzle applies a flow of ink droplets of a tracer marking fluid. Further, the flow of the tracer marking fluid from each nozzle may be controlled by a piezoelectric actuator.

In some embodiments, the marking device 121 is a drop on demand (DOD) printer. DOD represents droplet generation technology from a printhead that generates one or more multiple droplets upon command. If a command for multiple droplets is sent to the printhead, the multiple droplets are generated simultaneously (e.g., by multiple nozzles firing at simultaneously or nearly simultaneously), or alternatively with set time delays specified for each nozzle. Drop on demand includes, but is not limited to, industrial inkjet printers, piezo actuated printheads, thermal inkjet (TIJ), micro dispensing valves, large character printers, and other drop on demand print technology known in the art. In some examples, the drops are formed by the creation of a pressure pulse within the printhead. There are various methods for generating the pressure pulse for causing the drop to be ejected.

In some examples, the marking device 121 is configured to intermittently apply a tracer marking fluid to a first curable coating composition or a first coating formed from the first curable coating composition. Depending on the position of marking device 121 along the process pathway, the first curable coating composition may be a curable primary coating composition, a curable secondary coating composition, or a curable tertiary coating composition and the first coating may be a primary coating, a secondary coating, or a tertiary coating.

The tracer marking fluid includes a coloring agent and a carrier liquid. Embodiments of the carrier liquid include curable carrier liquids and non-curable carrier liquids. Curable carrier liquids include resins or formulations similar to the curable coating compositions applied by the coating system 118 (e.g., compositions include acrylate or methacrylate monomers or oligomers or other components with curable functional groups) . . . . Non-curable carrier liquids include solvents that dissolve or suspend the color agent. The solvent is a volatile liquid that evaporates to provide a tracer mark consisting of the coloring agent. Coloring agents include pigments and dyes.

As the glass fiber 130 progresses along the process pathway from draw furnace 112 to optical fiber spool 106, it cools and ultimately reaches room temperature. At positions along the process pathway at which the curable primary, secondary, and tertiary compositions are applied, glass fiber 130 is at an elevated temperature, such as a temperature greater than 40° C., or greater than 60° C., or greater than 80° C., or greater than 100° C., or greater than 120° C., or in a range from 40° C. to 140° C., or in a range from 50° C. to 130° C., or in a range from 60° C. to 120° C., or in a range from 70° C. to 110° C. Upon application, the temperature of the curable coating compositions, and coatings formed therefrom, will approximate the temperature of the glass fiber 130. Accordingly, the temperature of the surface (e.g., the surface of any of the curable coating compositions or coatings formed therefrom) to which the tracer marking fluid is applied by marking device 121 is within the ranges noted above for glass fiber 130.

The first lighting device 124a, the second lighting device 124b, and the third lighting device 124c (collectively “the lighting devices 124”) are, for example, ultraviolet lights for curing a curable coating composition disposed on the glass fiber. In some examples, the lighting devices 124 can be used to cure a coating layer applied from one of the coating cups 118. The ultraviolet light produced by lighting devices 124 induces photochemical curing reactions that transform the curable coating composition from a viscous liquid state to a rigid, solid state to form a coating. The photochemical reactions are typically polymerization reactions such as, for example, free radical polymerization reactions of acrylate and methacrylate functional groups.

For instance, a first lighting device 124 is configured to receive the glass fiber 130 with a first curable coating compositions disposed thereon from the first coating system 118 and to apply a first light to the first curable coating composition. The first light cures the first curable coating composition in order to form a first coating on the glass fiber 130. In some embodiments, the first curable coating composition directly contacts the glass fiber 130. In other embodiments, the first curable coating composition indirectly contacts the glass fiber 130. In some embodiments, a tracer marking fluid is disposed on the first curable coating composition and exposure of the tracer marking fluid to the first light cures the tracer marking fluid to form a tracer marking on the first coating or induces evaporation of a solvent of the tracer marking fluid to form a tracer marking on the first coating.

The marking device 121 can also be positioned at different locations along the process pathway of glass fiber 130, such as at a first printer location 126a, a second printer location 126b, and/or a third printer location 126c (collectively “the printer locations 126”). The marking device 121 is operably coupled to each coating system and each lighting device along the process pathway. At each printer location 126, the marking device 121 applies a tracer marking fluid that is used to generate a tracer marking. The tracer markings of different optical fibers or different positions along an optical fiber may differ in characteristics such as color or pattern, as will be described. As a non-limiting example, FIG. 1 illustrates that the marking device 121 is situated at the second printer location 126b. Other exemplary printer locations include first printer location 126a and third printer location 126c (shown schematically). Other printer locations (not shown) include at a position between first lighting device 124a and second coating system 118b or between second lighting device 124b and third coating system 118c.

Next, as an examples of a fiber draw process is further described the embodiment depicted in FIG. 1 in which marking device 121 is positioned along the process pathway between second coating system 118b and second lighting device 124b. Analogous descriptions apply to other embodiments herein in which marking device 121 is located at other positions along the process pathway.

The embodiment of FIG. 1 shows the optical fiber draw system 100 with a preform feed 109 delivers a glass preform to the draw furnace 112. The draw furnace 112 heats the glass preform and initiates of a glass fiber 130. The glass fiber 130 is guided to a cooling chamber 115, and the cooling chamber 115 lowers the temperature of the glass fiber 130 for subsequent stages.

After the cooling chamber 115, the glass fiber 130 is guided to a first coating system 118a for applying a first curable coating composition. Then, the glass fiber 130 is guided to a first lighting device 124a that cures the first curable coating composition to form a first coating on the glass fiber 130. Subsequently, the glass fiber 130 with first coating is guided to a second coating system 118b for applying a second curable coating composition to the first coating. The second curable coating composition surrounds and directly contacts the first coating.

Next, in the embodiment depicted in FIG. 1, the glass fiber 130 with the second curable coating composition disposed on the first coating is guided to the marking device 121 at the second printer location 126b. The marking device 121 applies a tracer marking fluid to the second curable coating composition. The tracer marking fluid can spread or be applied around a portion or the entire circumference of the glass fiber 130 to provide tracer markings that extend around some or all of the circumference of the glass fiber 130.

The second lighting device 124b is configured to receive the glass fiber 130 with the second curable coating composition and the tracer marking fluid disposed on the first coating and to apply second light to the second curable coating composition and the tracer marking fluid. The second light cures the second curable coating composition to form a second coating on the glass fiber 130 and the first coating. In embodiments in which the tracer marking fluid is curable, the second light from the second lighting device 124b cures the tracer marking fluid to form a tracer marking. In embodiments in which the tracer marking fluid is not curable, the second light from the second lighting device 124b may heat or otherwise facilitate evaporation of a solvent of the tracer marking fluid to form a tracer marking. The second light is preferably ultraviolet light.

Afterwards, the optical fiber draw system 100 guides the glass fiber 130 with tracer marking, second coating and first coating to a third coating system 118c to apply a third curable coating composition to the second coating and tracer marking. Then, the optical fiber draw system 100 guides the glass fiber 130 to a third lighting device 124c. The third lighting device 124c cures the third curable coating composition to form a third coating. In one embodiment, third curable coating composition includes an ink or a pigment and the third coating is colored. The tracer marking is also colored and preferably differs in color from the color of the third coating. It is further preferably in some embodiments for the third coating to be sufficiently thin such that it is translucent and the tracer markings covered by the third coating are visible through the third coating. Such embodiments provide identification of the fiber by both the color of the third coating and the color of the tracer markings. Subsequently, the optical fiber draw system 100 guides the glass fiber 130 with first coating, second coating, tracer marking and third coating to the optical fiber spool 106.

In various embodiments, the optical fiber draw system 100 generates the glass fiber 130 while applying the curable coating compositions and tracer marking fluid at a line speed greater than 20 m/s, or greater than 40 m/s, or greater than 50 m/s, or greater than 60 m/s, or greater than 70 m/s, or greater than 80 m/s, or in a range from 20 m/s to 100 m/s, or in a range from 20 m/s to 90 m/s, or in a range from 20 m/s to 80 m/s, or in a range from 30 m/s to 80 m/s, or in a range from 40 m/s to 70 m/s. The line speed corresponds to the speed at which the glass fiber (or glass fiber with one or more curable coating compositions or one or more coatings disposed thereon) is conveyed.

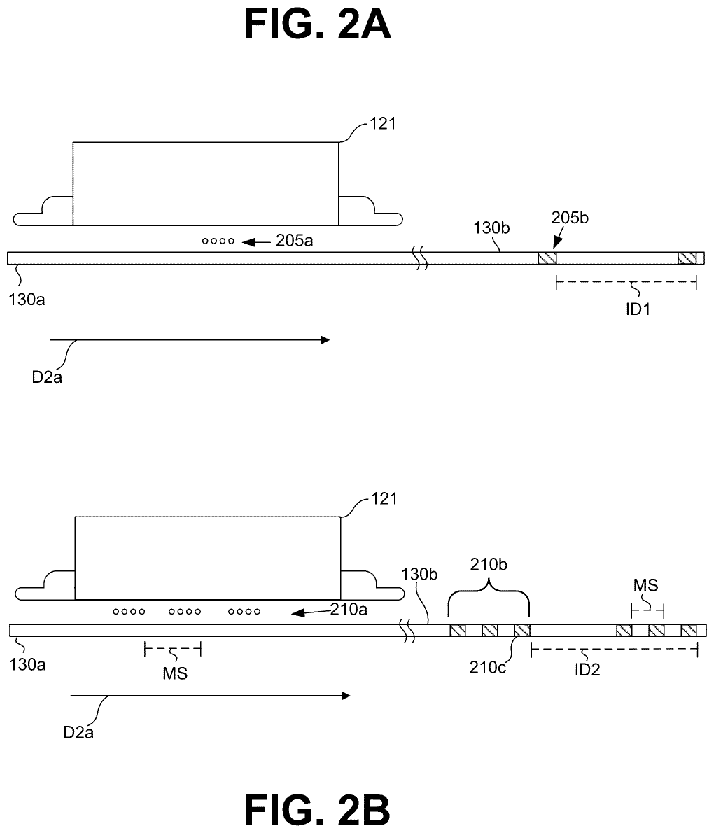

With reference to FIGS. 2A-2C, shown are illustrations of a marking device 121 and a glass fiber 130a during a drawing process according to one embodiment. FIG. 2A illustrates the marking device 121 applying a tracer marking fluid 205a to optical glass fiber 130a. Optical fiber 130a corresponds to glass fiber 130 at any position between first coating system 118a and third lighting device 124c along the process pathway. Accordingly, the outer surface of optical fiber 130a consists of a curable coating composition, a curable coating composition with tracer marking fluid, or a coating. The arrow D2a indicates the direction of motion of the optical fiber 130a along the process pathway during the draw process in the illustration. The tracer marking fluid 205a is dispensed from marking device 121 as a set of droplets simultaneously or near simultaneously being applied to the optical fiber 130a. The tracer marking fluid forms tracer marking 205b on marked optical fiber 130b upon curing (with a lighting device not shown in FIG. 2A) or evaporation of the carrier liquid of the tracer marking fluid. In some examples, the spacing between the droplets of tracer marking fluid 205a dispensed from marking device 121 is less than 250 micrometers in the direction D2a of draw. In one embodiment, the droplets of tracer marking fluid 205a are contiguous when disposed on optical fiber 130a. Tracer marking 205b is preferably a continuous marking without holes or gaps along the length of marked optical fiber 130b. As noted above, the circumferential extent of tracer marking 205b may be partial or complete in the azimuthal direction around optical fiber 130a. The tracer marking 205b may extend around at least 10%, or at least 20%, or at least 40%, or at least 60%, or at least 80% or 100%, or between 20% and 100%, or between 40% and 90%, or between 50% and 80% of the circumference of marked optical fiber 130b.

In some examples, the tracer markings 205b are repeated at an interval distance ID1. The interval distance ID1 is implemented to ensure there is a consistent spacing between tracer markings 205b. The tracer markings 205b are repeated at predetermined positions along the length of the marked optical fiber 130b so that a user does not have to access one particular location of the marked optical fiber 130b, such as an end, in order to identify the marked glass optical fiber 130b. The interval distance ID1 is controlled in the draw process by intermittently activating marking device 121 to intermittently dispense tracer marking fluid 205a at spaced apart positions corresponding to the specified interval distance ID1. In some examples, the interval distance ID1 can be determined with respect to the length of the tracer marking 205b by a ratio of dimensions. For example, the length of the tracer marking 205b to the interval distance ID1 may be a ratio of 1:2 (e.g., the tracer marking length is 10 mm and interval distance ID1 is 20 mm), 3:5, or other suitable ratios. It is noted that the selection of the ratio of length to interval spacing provides an additional degree of freedom in fiber identification.

In some examples, the interval distance ID1 can be in a range from 150 millimeters to 300 millimeters. In some preferred embodiments, the interval distance ID1 is no more than 250 millimeters. In some instances, the internal distance is specified by a fiber optical standard, such as the TIA-598D standard for example.

FIG. 2B illustrates the marking device 121 dispensing multiple sets of droplets of tracer marking fluid 210a to the optical fiber 130a. The arrow D2a indicates the direction of motion of the optical fiber 130a along the process pathway during the draw process in the illustration. The multiple sets of tracer marking fluid 210a are simultaneously applied to the optical fiber 130a. Three sets of droplets of the tracer marking fluid 210a are shown in FIG. 2B, but any number of sets of droplets may be dispensed simultaneously by marking device 121. In one embodiment, the spacing between droplets of tracer marking fluid 210a within a set is less than 250 micrometers and the gap (closest spacing) between consecutive sets of droplets of tracer marking fluid 210a is greater than 500 micrometers, or greater than 1.0 millimeters, or greater than 2.0 millimeters, or greater than 4.0 millimeters. In another embodiment, the gap (closest spacing) between consecutive sets of droplets of tracer marking fluid 210a is a factor of 2 or more, or a factor of 4 or more, or a factor of 8 or more, or a factor of 16 or more greater than the spacing between droplets of tracer marking fluid 210a with a set. The sets of tracer marking fluid form compound tracer marking 210b upon curing (with a lighting device not shown in FIG. 2B) or evaporation of the carrier liquid of the tracer marking fluid. Compound tracer marking 210b consists of a series of tracer markings 210c spaced apart by a mark spacing MS. Each of the tracer markings 210c is similar to tracer marking 205b in FIG. 2A and may extend circumferentially about marked optical fiber 130b as described above. The mark spacing MS is greater than 500 micrometers, or greater than 1.0 millimeters, or greater than 2.0 millimeters, or greater than 4.0 millimeters. The compound tracer markings 210b are repeated on an interval distance ID2. The internal distance ID2 is greater than the mark spacing MS and is implemented to ensure there is a consistent spacing distance between the compound tracer markings 210b. In some examples, the interval distance ID2 can be in a range from a range from 150 millimeters to 300 millimeters. The interval distance ID2 is controlled in the draw process by intermittently activating marking device 121 to intermittently dispense tracer marking fluid 210a at spaced apart positions corresponding to the specified interval distance ID2.

Referring now to FIG. 2C, shown is a cross-sectional view of another optical fiber system 225. The cross-section view is from a top down view of the optical fiber system 225. The optical fiber system 225 comprises a first marking device 228a and a second marking device 228b (collectively “the marking devices 228”) configured to print tracer markings 205b or compound tracer markings 210b on the optical fiber 231 from different angles of orientation in the azimuthal or circumferential direction. As such, the first marking device 228a can be located at a first position and the second marking device 228b can be located at a second position about a circumference of the covered glass fiber 231. With two marking devices 228 positioned from different angles of orientation, a greater circumferential coverage area of marking for the optical fiber 231 is achieved. For instance, the optical fiber system 225 is configured to have the entire or substantially-near the entire circumference of the optical fiber 231 covered with a tracer marking 205b or compound tracer marking 210b. In these scenarios, the marking devices 228 are positioned at an angle 234 in a range between 90 degrees to 270 degrees with respect to each other around the circumference of the optical fiber 231. The angle 234 represents an angle degree difference between a first print axis of the first marking device 228a and a second print axis of the second marking device 228b. The first print axis and the second print axis represents a direction for applying the droplets or sets of droplets of tracer marking fluid to the optical fiber 231.

Additionally, in some embodiments, the first marking device 228a and the second marking device 228b can be positioned in a common plane orthogonal to draw direction D1 of FIG. 1. In other embodiments, the first marking device 228a and the second marking device 228b are offset along draw direction D1 and not positioned in a common plane orthogonal thereto. The offset can be advantageous in situations where a continuous ring mark is desired. For instance, if the resolution (e.g., dots per inch) of the marking devices 228 combined with the droplet size are not sufficient to create a continuous ring mark (that is, a mark extending around the entire circumference of the optical fiber) and there is a drop gap problem, then the offset of a dual printhead configuration may solve the problem.

The embodiment depicted in FIG. 2C depicts two marking devices 228. In other embodiments, three or more, or four or more, or five or more, or six or more, or between 1 and 8, or between 2 and 6 marking devices 228 may be deployed to print tracer markings 205b or compound tracer markings 210b around part of all of the circumference of optical fiber 231. The two or more marking devices 128 may be located in a common plane orthogonal to draw direction D1 or in different orthogonal planes positioned along draw direction D1. Some of multiple marking devices 128 may be in a common plane orthogonal to draw direction D1 and others of multiple marking devices 128 may be located in different plane(s) orthogonal to draw direction D1.

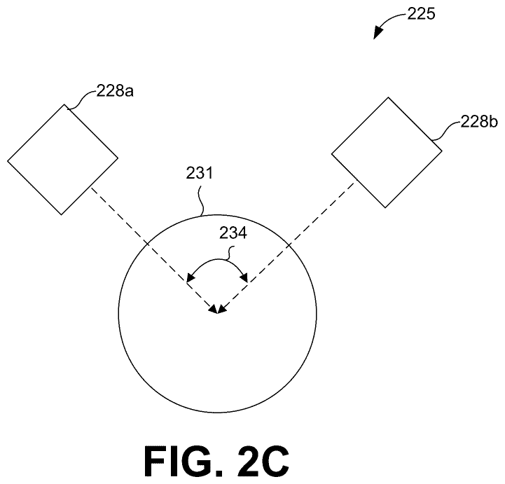

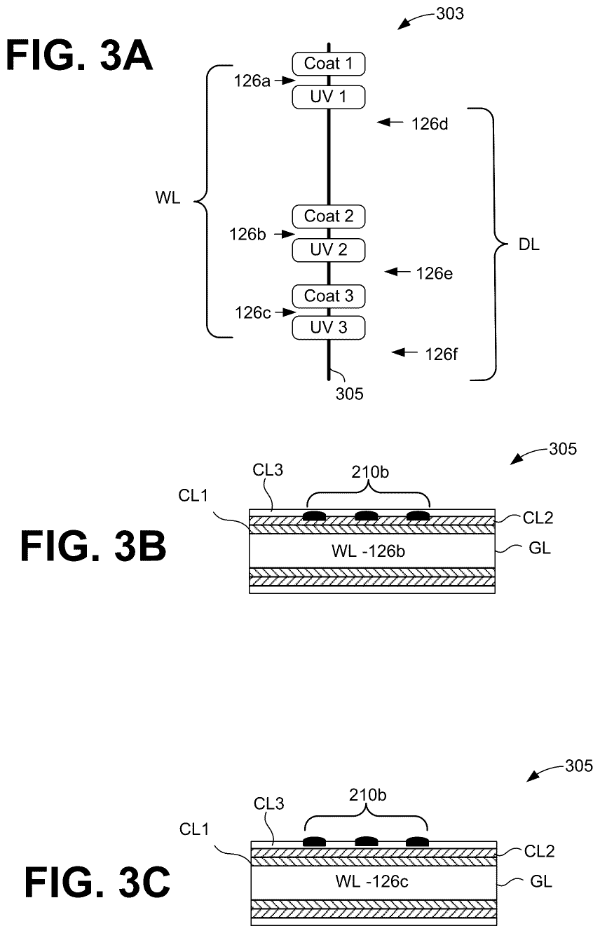

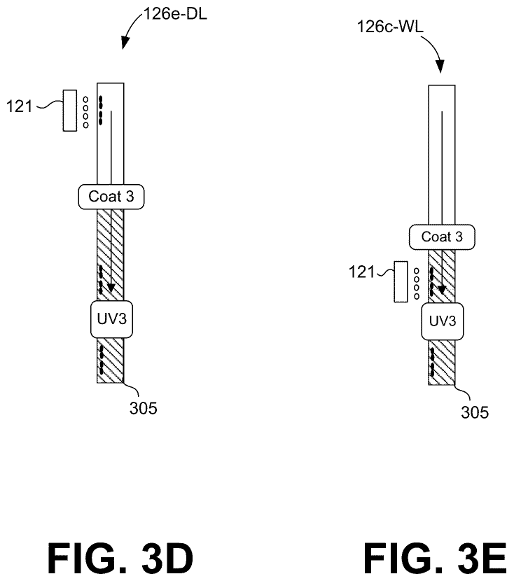

With reference to FIG. 3A, shown is an optical fiber draw process 303 for different printer locations126a-126f (collectively “the printer locations 126”) for the marking device 121 in the optical fiber draw system 100. The optical fiber draw process 303 illustrates a sequence for developing various layers on an optical fiber 305 during the optical fiber draw process 303. The optical fiber 305 includes one or more coatings or layers of curable coating composition. For example, Coat 1, Coat 2, and Coat 3 referred to in FIGS. 3A, 3D, and 3E represent application of a curable coating composition to glass fiber 130 or optical fiber 305 by one of the coating systems 118. UV 1, UV 2, and UV 3 referred to in FIGS. 3A, 3D, and 3E represent exposure of optical fiber 305 to curing light from a lighting device 124.

In FIG. 3A, the printer locations 126a-c represent wet locations WL for the marking device 121. The wet locations WL correspond to a printer location 126 in which the trace marker fluid is applied to a curable coating composition disposed on glass fiber 130. The curable coating composition is applied by one of the coating systems 118. In some examples, a single wet location WL (e.g., one of printer locations 126a-c) is selected for printing the tracer marking 205 or compound tracer marking 210.

In one example, the optical fiber draw system 100 positions the marking device 121 at the second printer location 126b for a selected wet location WL. In this example, the optical fiber draw system 100 applies a first curable coating composition to the glass fiber 130 at Coat 1 using the first coating system 118a. At UV1, the optical fiber draw system 100 applies an ultraviolet or other curing light to the first curable coating composition using the first lighting device 124a. The ultraviolet or other curing light cures the first curable coating composition on the glass fiber 130 to form a first coating (e.g., a primary coating).

At Coat 2, the optical fiber draw system 100 applies a second curable coating composition to the first coating using the second coating system 118b. At the arrow associated with the second printer location 126b, the marking device 121 dispenses tracer marking fluid 205a or 210a on the second curable coating composition. At UV2, the optical fiber draw system 100 applies ultraviolet or other curing light to the second curable coating composition and tracer marking fluid 205a or 210a using the second lighting device 124b. The ultraviolet or other curing light cures the second curable coating composition to form a second coating on the first coating. In embodiments in which the tracer marking fluid 205a or 210a is curable, the second light also cures the tracer marking fluid 205a to form a tracer marking 205b or compound tracer marking 210b. As a result, in this embodiment, the tracer marking 205b or the compound tracer marking 210b and the second coating layer are cross linked or chemically bonded together to form a monolithic layer. In embodiments in which the tracer marking fluid 205a or 210a is non-curable, the light from second lighting device 124b may provide heat to facilitate evaporation of solvent from the tracer marking fluid 205a or 210a to form tracer marking 205b or compound tracer marking 210b.

At Coat 3, the optical fiber draw system 100 applies a third curable coating composition to the second coating using the third coating system 118c. At UV3, the optical fiber draw system 100 applies an ultraviolet or other curing light to the third curable coating composition using the third lighting device 124c. The ultraviolet or other curing light cures the third curable coating composition to form a third coating on the second coating.

Corresponding descriptions apply for embodiments in which the marking device is located at wet locations WL 126a or 126c.

Printer locations 126d-f each represent a dry location DL for the marking device 121. The dry locations DL represent one or more printer locations 126 in which the trace marker fluid is applied to a coating. The coatings are created by applying an ultraviolet or other curing light from one of the lighting devices 124. In some examples, a dry location DL (e.g., one or more of printer locations 126d-f) is selected for applying tracer marking fluid 205a or 210a to a coating.

For example, in one embodiment, the optical fiber draw system 100 positions the marking device 121 at the fifth printer location 126e for a selected dry location DL. At Coat 1, the optical fiber draw system 100 applies a first curable coating composition to glass fiber 130 using the first coating system 118a. At UV1, the optical fiber draw system 100 applies an ultraviolet or other curing light to the first curable coating composition using the first lighting device 124a. The ultraviolet or other curing light cures the first curable coating composition to form a first coating on glass fiber 130.

At Coat 2, the optical fiber draw system 100 applies a second curable coating composition to the first coating using the second coating system 118b. At UV2, the optical fiber draw system 100 applies an ultraviolet or other curing light to the second curable coating composition using the second lighting device 124b. The ultraviolet or other curing light cures the second curable coating composition to form a second coating on the on the first coating. At the fifth printer location 126e (a dry location DL), the marking device 121 applies tracer marking fluid 205a or 210a on the second coating.

At Coat 3, the optical fiber draw system 100 applies a third curable coating composition to the second coating and the tracer marking fluid 205a or 210a using the third coating system 118c. In embodiments in which tracer marking fluid 205a or 210a is not curable, solvent evaporation may occur between UV2 and Coat 3. At UV3, the optical fiber draw system 100 applies an ultraviolet or other curing light to the third curable coating composition and tracer marking fluid 205a or 210a using the third lighting device 124c. The ultraviolet or other curing light cures the third curable coating composition to form a third coating. In embodiments in which the tracer marking fluid 205a or 210a is curable, the light from third lighting device 124c also cures the tracer marking fluid 205a or 210a to form tracer marking 205b or compound tracer marking 210b under the third coating.

Corresponding descriptions apply for embodiments in which the marking device is located at dry locations DL 126d or 126f.

Referring now to FIGS. 3B and 3C, shown are cross sectional drawings of the optical fiber 305 after the draw process has been completed. FIG. 3B illustrates a cross-sectional view of the optical fiber 305 in a scenario when the marking device 121 is positioned at the second printer location 126b, as referenced above in FIG. 3A and also shown in FIG. 3E. FIG. 3B illustrates an embodiment in which a compound tracer marking 210b has been printed on the optical fiber 305.

In FIG. 3B, the optical fiber 305 includes a glass fiber GL, a first coating CL1, a second coating CL2, a third coating CL3, and a compound tracer marking 210b. The first coating CL1, the second coating CL2, and the third coating CL3 correspond to the coatings formed from by curing the first, second, and third curable coating compositions applied at stages Coat 1, Coat 2, and Coat 3 in FIG. 3A.

In this example, the compound tracer marking 210b has been formed on the second coating CL2. The third coating CL3 has been formed over the compound tracer marking 210b. The third coating CL3 may be comprised of a translucent material in order to make the compound tracer marking 210b visible to a user. In some embodiments, the third coating CL3 is colored with a pigment or other coloring agent present in the third curable coating composition.

Next, FIG. 3C illustrates a cross-sectional view of the optical fiber 305 in an embodiment in which the marking device 121 is located at the third printer location 126c, as referenced above in FIG. 3A. FIG. 3C illustrates a compound tracer marking 210b on optical fiber 305.

In FIG. 3C, the optical fiber 305 includes a glass fiber GL, a first coating CL1, a second coating CL2, a third coating CL3, and a compound tracer marking 210. The first coating CL1, the second coating CL2, and the third coating CL3 corresponds to coatings formed from by curing the first, second, and third curable coating compositions applied at the coating stages Coat 1, Coat 2, and Coat 3 in FIG. 3A.

In this example, the compound tracer marking 210b has been formed on the third coating CL3. In some embodiments, the third coating CL3 is colored with a pigment or other coloring agent present in the third curable coating composition. Since the compound tracer marking 210b is formed on the third coating CL3, the compound tracer marking 210b may be more visible than in the embodiment of FIG. 3B.

Referring now to FIGS. 3D-3E, shown are alternative views for the optical fiber draw process 303 shown in FIG. 3A with placement of the marking device 121 at various printer locations 126 FIG. 3D illustrates placement of the marking device 121 at the fifth printer location 126e, a dry location (126e-DL). At the fifth printer location 126e-DL, the marking device 121 applies the tracer marking fluid 210a on the second coating and optical fiber 305 proceeds to Coat 3 and UV3 for formation of the third coating.

FIG. 3E illustrates placement of the marking device 121 at the third printer location 126c, a wet location (126c-WL). At the third printer location 126c-WL, the marking device 121 the tracer marking fluid 210a on the third curable coating composition. The optical fiber 305 then proceeds to UV3 for curing of the third curable coating composition to form the third coating.

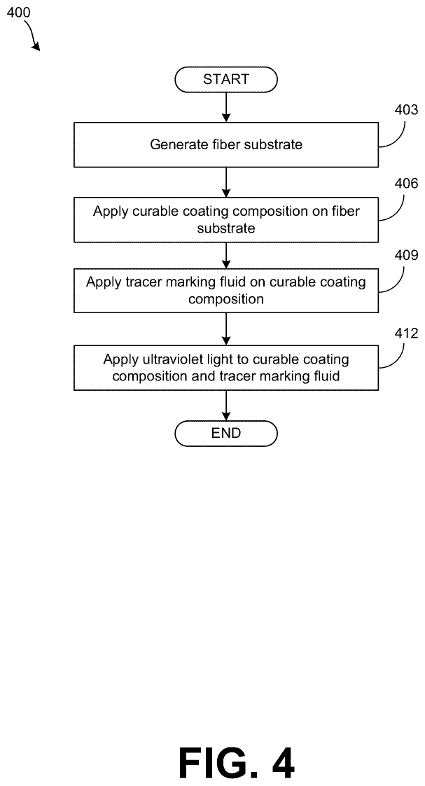

Referring next to FIG. 4, shown is a flowchart that provides one example method 400 of drawing optical fibers 305 that includes online formation of tracer markings 205b or compound tracer markings 210b with placement of the marking device 121 at a wet printer location according to various embodiments. It is understood that the flowchart of FIG. 4 provides merely an example of the many different types of sequences that may be employed to implement the method of manufacturing as described herein.

Beginning with step 403, in one embodiment, the method 400 of drawing optical fibers 305 by way of the optical fiber draw system 100 (FIG. 1) includes generating a fiber substrate. The fiber substrate includes glass fiber 130 and optionally includes a coating disposed on glass fiber 130. The optical fiber draw system 100 generates the glass fiber 130 in a draw furnace 112 by heating a glass preform to soften its tip to initiate formation of the glass fiber 130.

In step 406, a curable coating composition is applied to the fiber substrate. A coating system 118 of the optical fiber draw system 100 applies the curable coating composition.

In step 409, a tracer marking fluid is applied to the curable coating composition. The tracer marking fluid 205a or 210a is dispensed to enable formation of a tracer marking 205b or a compound tracer marking 210b. The tracer marking fluid 205a or 210a is applied intermittently to provide a specified interval spacing ID1 or ID2 between tracer markings 205b or compound tracer markings 210b. In some examples, the method 400 may include dispensation of tracer marking fluid 205a or 210a from two or more ink marking devices 121 in step 409. For instance, multiple marking devices 121 may be used to increase the circumferential coverage of the tracer marking 205a or compound tracer marking 210a on the fiber substrate, as described in FIG. 2C.

In step 412, ultraviolet or other curing light is applied to the curable coating composition and the tracer marking fluid 205a or 210a to form a coating.

The method 400 of drawing optical fibers 305 by way of the optical fiber draw system 100 may include applying an additional one or more curable coating compositions with additional coating systems 118 and curing the one or more additional curable coating compositions with additional lighting devices 124. For example, if the fiber substrate includes glass fiber 130 and a primary coating, two additional coatings are formed. Alternatively, fiber substrate includes glass fiber 130, a primary coating and a secondary coating, then one additional coating is formed. In another implementation, if the third printer location 126c has been setup fiber substrate includes glass fiber 130, a primary coating, a secondary coating, and a tertiary coating, then no additional coatings are formed. Then, the method 400 of the optical fiber draw system 100 proceeds to the end and optical fiber 305 is collected on optical fiber spool 106.

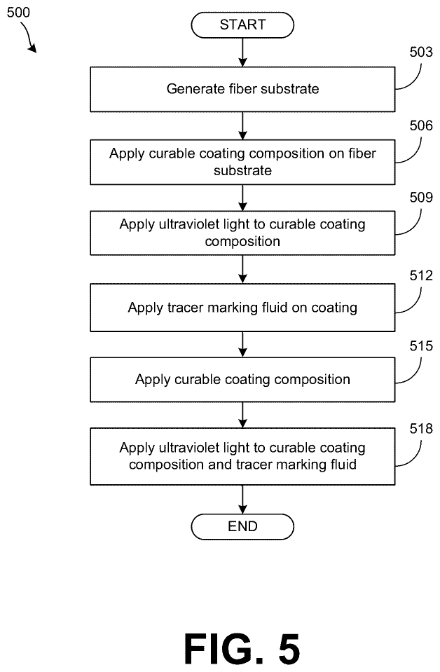

Referring next to FIG. 5, shown is a flowchart that provides one example method 500 of drawing optical fibers that includes online formation of tracer markings 205b or compound tracer markings 210b with placement of the marking device 121 at a dry printer location according to various embodiments. It is understood that the flowchart of FIG. 5 provides merely an example of the many different types of sequences that may be employed to implement the method of manufacturing as described herein.

Beginning with step 503, in one embodiment, the method 500 of drawing optical fibers 305 by way of the optical fiber draw system 100 (FIG. 1) include generating a fiber substrate. The fiber substrate includes glass fiber 130 and optionally includes a coating disposed on glass fiber 130. The optical fiber draw system 100 generates the glass fiber 130 in a draw furnace 112 by heating a glass preform to to soften its tip to initiate formation of the glass fiber 130.

In step 506, a curable coating composition is applied to the fiber substrate. A coating system 118 of the optical fiber draw system 100 applies the curable coating composition.

In step 509, ultraviolet or other curing is applied to the curable coating composition to form a coating.

In step 512, a tracer marking fluid is applied to the coating. The tracer marking fluid 205a or 210a is dispensed to enable formation of a tracer marking 205b or a compound tracer marking 210b. The tracer marking fluid 205a or 210a is applied intermittently to provide a specified interval spacing ID1 or ID2 between tracer markings 205b or compound tracer markings 210b. In some examples, the method 400 may include dispensation of tracer marking fluid 205a or 210a from two or more ink marking devices 121 in step 512. For instance, multiple marking devices 121 may be used to increase the circumferential coverage of the tracer marking 205a or compound tracer marking 210a on the fiber substrate, as described in FIG. 2C.

In step 515, a curable coating composition is applied to the coating formed in step 509 and tracer marking fluid 205a or 210a applied in step 512. A coating system 118 of the optical fiber draw system 100 applies the curable coating composition.

In step 518, ultraviolet or other curing light is applied to the curable coating composition applied in step 515 and the tracer marking fluid 205a or 210a to form a coating. If the tracer marking fluid 205a or 210a is curable, it cures along with the curable coating composition applied in step 515 in this step. Then, the method 500 of the optical fiber draw system 100 proceeds to the end and optical fiber 305 is collected on optical fiber spool 106.

Optical Fiber Coatings. The transmissivity of light through an optical fiber is dependent on the properties of the coatings applied to the glass fiber. The coatings typically include a primary coating and a secondary coating, where the secondary coating surrounds the primary coating and the primary coating contacts the glass fiber (which includes a central core region surrounded by a cladding region). In a typical configuration, the primary coating directly contacts the glass fiber and the secondary coating directly contacts the primary coating. The secondary coating is a harder material (higher Young's modulus) than the primary coating and is designed to protect the glass fiber from damage caused by abrasion or external forces that arise during processing, handling, and installation of the optical fiber. The primary coating is a softer material (lower Young's modulus) than the secondary coating and is designed to buffer or dissipates stresses that result from forces applied to the outer surface of the secondary coating. Dissipation of stresses within the primary coating attenuates the stress and minimizes the stress that reaches the glass fiber. The primary coating is especially important in dissipating stresses that arise from the microbending that the optical fiber encounters when deployed in a cable. The bending stresses transmitted to the glass fiber need to be minimized because bending stresses create local perturbations in the refractive index profile of the glass fiber. The local refractive index perturbations lead to intensity losses for the light transmitted through the glass fiber. By dissipating stresses, the primary coating minimizes intensity losses caused by microbending.

Primary and secondary coatings are typically formed by applying a curable coating composition to the glass fiber as a viscous liquid and curing. The optical fiber may also include a tertiary coating that surrounds the secondary coating. The tertiary coating may include pigments, inks or other coloring agents to mark the optical fiber for identification purposes and typically has a Young's modulus and composition similar to the secondary coating.

The primary coating is a cured product of a radiation-curable primary coating composition that includes an oligomer, a monomer, and a photoinitiator. The oligomer preferably includes a polyether urethane diacrylate compound. In one embodiment, the polyether urethane diacrylate compound has a linear molecular structure. In one embodiment, the oligomer is formed from a reaction between a diisocyanate compound, a polyol compound, and a hydroxy acrylate compound. The reaction forms a urethane linkage upon reaction of an isocyanate group of the diisocyanate compound and an alcohol group of the polyol. The hydroxy acrylate compound reacts to terminate residual isocyanate groups that are present in the composition formed from reaction of the diisocyanate compound and polyol compound. Termination of residual isocyanate groups with a hydroxy acrylate compound converts terminal isocyanate groups to terminal acrylate groups.

The curable primary coating composition further includes one or more monomers. The one or more monomers is/are selected to be compatible with the oligomer, to control the viscosity of the primary coating composition to facilitate processing, and/or to influence the physical or chemical properties of the coating formed as the cured product of the primary coating composition. The monomers include curable monomers such as ethylenically-unsaturated compounds, ethoxylated acrylates, ethoxylated alkylphenol monoacrylates, propylene oxide acrylates, n-propylene oxide acrylates, isopropylene oxide acrylates, monofunctional acrylates, monofunctional aliphatic epoxy acrylates, multifunctional acrylates, multifunctional aliphatic epoxy acrylates, and combinations thereof.

The secondary coating is a cured product of a curable secondary coating composition that includes a monomer, a photoinitiator, and an optional oligomer. The secondary coating is formed as the cured product of a curable secondary coating composition that includes one or more monomers. The monomers preferably include ethylenically unsaturated compounds, such as acrylates and methacrylates. The optional oligomer is preferably a urethane acrylate oligomer. Representative primary and secondary coating compositions are disclosed in U.S. Pat. No. 10,775,557, the disclosure of which is incorporated herein by reference.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system for forming an optical fiber, comprising:
a draw furnace configured to produce a glass fiber from a glass preform;
a first coating system configured to receive the glass fiber and to deliver a first curable coating composition to the glass fiber, the first curable coating composition surrounding the glass fiber;
a first lighting device configured to receive the glass fiber from the first coating system and to apply first light to the first curable coating composition, the first light curing the first curable coating composition to form a first coating on the glass fiber; and
a marking device operably coupled to the first coating system or the first lighting device, the marking device configured to apply a tracer marking fluid to the first curable coating composition or the first coating, the tracer marking fluid comprising a coloring agent and a carrier liquid.

2. The optical fiber draw system of claim 1, wherein the first curable coating composition directly contacts the glass fiber.

3. The optical fiber draw system of claim 1, wherein the marking device applies the tracer marking fluid to the first curable coating composition.

4. The optical fiber draw system of claim 1, wherein the marking device is a drop on demand device.

5. The optical fiber draw system of claim 1, wherein the marking device comprises a plurality of nozzles arranged in a parallel configuration, each of the nozzles providing some of the tracer marking fluid.

6. The optical fiber draw system of claim 1, further comprising a second coating system operably coupled to the marking device, the second coating system configured to receive the glass fiber and to deliver a second curable coating composition to the glass fiber, the second curable coating composition surrounding and directly contacting the glass fiber.

7. The optical fiber draw system of claim 6, further comprising a second lighting device configured to receive the glass fiber from the second coating system and to apply second light to the second curable coating composition, the second light curing the second curable coating composition to form a second coating on the glass fiber.

8. The optical fiber draw system of claim 1, wherein the marking device is configured to intermittently apply the tracer marking fluid to the first curable coating composition or the first coating.

9. The optical fiber draw system of claim 1, wherein the marking device is configured to apply the tracer marking fluid as a plurality of droplets to the first curable coating composition or the first coating.

10. The optical fiber draw system of claim 9, wherein the plurality of droplets is arranged as a contiguous series on the first curable coating composition or the first coating.

11. A method of making an optical fiber comprising:
drawing a glass fiber from a heated glass preform;
directing the glass fiber to a first coating system, the first coating system applying a first curable coating composition to the glass fiber, the first curable coating composition surrounding the glass fiber; and
directing the glass fiber with first curable coating composition to a first lighting device, the first lighting device providing first light to cure the first curable coating composition to form a first coating, the directing including applying a tracer marking fluid to the first curable coating composition or the first coating.

12. The method of claim 11, wherein the first curable coating composition is applied to directly contact the glass fiber.

13. The method of claim 11, wherein the tracer marking fluid is applied to the first curable coating composition.

14. The method of claim 11, further comprising:
directing the glass fiber to a second coating system, the second coating system applying a second curable coating composition to the glass fiber, the second curable coating composition surrounding and directly contacting the glass fiber.

15. The method of claim 14, further comprising:
directing the glass fiber with second curable coating composition to a second lighting device, the second lighting device providing second light to cure the second curable coating composition to form a second coating on the glass fiber.

16. The method of claim 15, wherein the first curable coating composition surrounds the second coating.

17. The method of claim 11, wherein the tracer marking fluid is applied intermittently to the first curable coating composition or the first coating.

18. The method of claim 11, wherein the tracer marking fluid is applied as a plurality of droplets to the first curable coating composition or the first coating.

19. The method of claim 18, wherein the plurality of droplets is arranged as a contiguous series on the first curable coating composition or the first coating.

20. The method of claim 11, wherein the first light cures the tracer marking fluid.
